(19) United States
(12) Patent Application Publication
(10) Pub. No.: US 2025/0274655 A1
(43) Pub. Date: Aug. 28, 2025

(54) ELECTRONIC DEVICE COMPRISING CAMERA AND OPERATION METHOD THEREFOR

(71) Applicant: Samsung Electronics Co., Ltd., Suwon-si, Gyeonggi-do (KR)

(72) Inventors: Changhoon KANG, Suwon-si (KR); Sunho MOON, Suwon-si (KR); Daehun AN, Suwon-si (KR); Byounggeun CHOI, Suwon-si (KR); Bosung KIM, Suwon-si (KR); Dongjun SEO, Suwon-si (KR)

(21) Appl. No.: 19/208,071

(22) Filed: May 14, 2025

Related U.S. Application Data
(63) Continuation of application No. PCT/KR2023/019361, filed on Nov. 28, 2023.

(30) Foreign Application Priority Data
Nov. 28, 2022 (KR) 10-2022-0161674
Jan. 11, 2023 (KR) 10-2023-0004190

(51) Int. Cl. H04N 23/661; H04N 7/18; H04N 23/63

(52) U.S. Cl. CPC H04N 23/661; H04N 7/183; H04N 23/632

(57) ABSTRACT

An electronic device is provided. The electronic device includes a camera, memory, including storage media, storing instructions, and at least one processor communicatively coupled to the camera and the memory, wherein the instructions, when executed by the at least one processor individually or collectively, cause the electronic device to execute an application related to an operation of the camera, execute a client distinct from the application, determine a configuration of an image stream, based on information on image streams supportable in relation to the camera, initiate the operation of the camera, based on the determined configuration of the image stream, obtain image data corresponding to the determined configuration of the image stream, based on a request of the application, store the image data in a buffer allocated to the memory, and allow the client to obtain at least one image stream, based on the image data, through the buffer.

### CROSS-REFERENCE TO RELATED APPLICATION(S)

This application is a continuation application, claiming priority under 35 U.S.C. § 365(c), of an International application No. PCT/KR2023/019361, filed on Nov. 28, 2023, which is based on and claims the benefit of a Korean patent application number 10-2022-0161674, filed on Nov. 28, 2022, in the Korean Intellectual Property Office, and of a Korean patent application number 10-2023-0004190, filed on Jan. 11, 2023, in the Korean Intellectual Property Office, the disclosure of each of which is incorporated by reference herein in its entirety.

### BACKGROUND

### 1. Field

The disclosure relates to an electronic device including a camera, and an operation method thereof.

### 2. Description of Related Art

With the development of digital technologies, various types of electronic devices, such as a mobile communication terminal, a personal digital assistant (PDA), an electronic organizer, a smartphone, a tablet personal computer (PC), or a wearable device, are widely used. The electronic devices may provide various functions. For example, the electronic devices may execute at least one application in foreground and/or background to provide at least one function.

The electronic device may provide the various functions by using a designated operating system (e.g., Android™ operating system (OS)). For example, the electronic device may support a plurality of functions provided by using a camera.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device including a camera, and an operation method thereof.

Additional aspects will be set forth in part in the description which follows and, in part, will be apparent from the description, or may be learned by practice of the presented embodiments.

In accordance with an aspect of the disclosure, an electronic device is provided. The electronic device includes a camera, memory, including one or more storage media, storing instructions, and at least one processor communicatively coupled to the camera and the memory, wherein the instructions, when executed by the at least one processor individually or collectively, cause the electronic device to execute an application related to an operation of the camera, execute a client distinct from the executed application, determine a configuration of an image stream, based on information on image streams supportable in relation to the camera, initiate the operation of the camera, based on the determined configuration of the image stream, obtain image data corresponding to the determined configuration of the image stream through the camera, based on a request of the executed application, store the image data in a buffer allocated to the memory, and allow the client to obtain at least one image stream, based on the image data, through the buffer.

In accordance with another aspect of the disclosure, a method of operating an electronic device including a camera is provided. The method includes executing an application related to an operation of the camera, executing a client distinct from the executed application, determining a configuration of an image stream, based on information on image streams supportable in relation to the camera, initiating the operation of the camera, based on the determined configuration of the image stream, obtaining image data corresponding to the determined configuration of the image stream through the camera, based on a request of the executed application, and providing the executed application with at least one first image stream requested by the application, based on the image data, and providing the client with at least one second image stream requested by the client.

In accordance with another aspect of the disclosure, one or more non-transitory computer-readable storage media storing one or more computer programs including computer-executable instructions that, when executed by at least one processor of an electronic device individually or collectively, cause the electronic device to perform operations are provided. The operations include executing an application related to an operation of the camera, executing a client distinct from the executed application, determining a configuration of an image stream, based on information on image streams supportable in relation to the camera, initiating the operation of the camera, based on the determined configuration of the image stream, obtaining image data corresponding to the determined configuration of the image stream through the camera, based on a request of the executed application, and providing the executed application with at least one first image stream requested by the application, based on the image data, and providing the client with at least one second image stream requested by the client.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to an embodiment of the disclosure;

FIG. 2 is a block diagram for an electronic device according to an embodiment of the disclosure;

FIG. 3 is a flowchart illustrating a process in which an electronic device provides at least one image stream to a client according to an embodiment of the disclosure;

FIG. 4 is a flowchart illustrating a process in which an electronic device determines an image stream and initiates an operation of a camera according to an embodiment of the disclosure;

FIG. 5 illustrates an electronic device configuring an image stream supportable for a camera according to an embodiment of the disclosure;

FIG. 6 illustrates an electronic device configuring at least one image stream by adding a surface when a stream is addable according to an embodiment of the disclosure;

FIG. 7 illustrates an electronic device configuring at least one image stream by including a shared stream according to an embodiment of the disclosure;

FIG. 8 illustrates an electronic device configuring at least one image stream by including a replacement stream according to an embodiment of the disclosure;

FIG. 9 is a flowchart illustrating a process in which an electronic device obtains image data according to an embodiment of the disclosure;

FIG. 10 is a flowchart illustrating a process in which an electronic device transfers an image to a client, based on image data obtained by the electronic device according to an embodiment of the disclosure;

FIG. 11 is a flowchart illustrating a process in which an electronic device transfers an image to a client, based on whether at least one image stream is configured by including a replacement stream according to an embodiment of the disclosure;

FIG. 12 is a flowchart illustrating a process in which an electronic device performs at least one image processing operation to transfer an image to a client according to an embodiment of the disclosure;

FIG. 13 illustrates a user interface for configuring whether an electronic device allows a client to request for surface injection according to an embodiment of the disclosure;

FIG. 14 illustrates an electronic device providing a service through a different client in a state where a camera is occupied by an application according to an embodiment of the disclosure; and

FIG. 15 is a block diagram illustrating a module included in an electronic device according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Functions of electronic devices provided by the Android operating system (OS) or device vendors may be continuously added or improved. In addition, when a client (e.g., an application) which uses a function of a camera is executed on the Android operation system, the client may exclusively occupy the camera. For example, a process of another application (another client) may not be able to access a frame of a captured image or a preview image provided by a camera application through one camera. In order for a client different from the client occupying the camera to provide a service by using the frame obtained through the camera, it may be required to modify the client itself occupying the camera so as to provide the frame to the different client. However, it may be difficult to modify an application itself provided by a third party according to a function of each electronic device.

Various embodiments may provide an electronic device or an operation method thereof, which allows functions provided by other clients to be provided while an application is used without modification for the application, by providing a background service capable of obtaining frames captured through a camera device even while the camera device is occupied and/or used by an executed application.

Technical issues to be addressed in the disclosure are not limited to the technical problems mentioned above, and other technical problems not mentioned herein may be clearly understood by those skilled in the art to which the disclosure pertains from the following descriptions.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

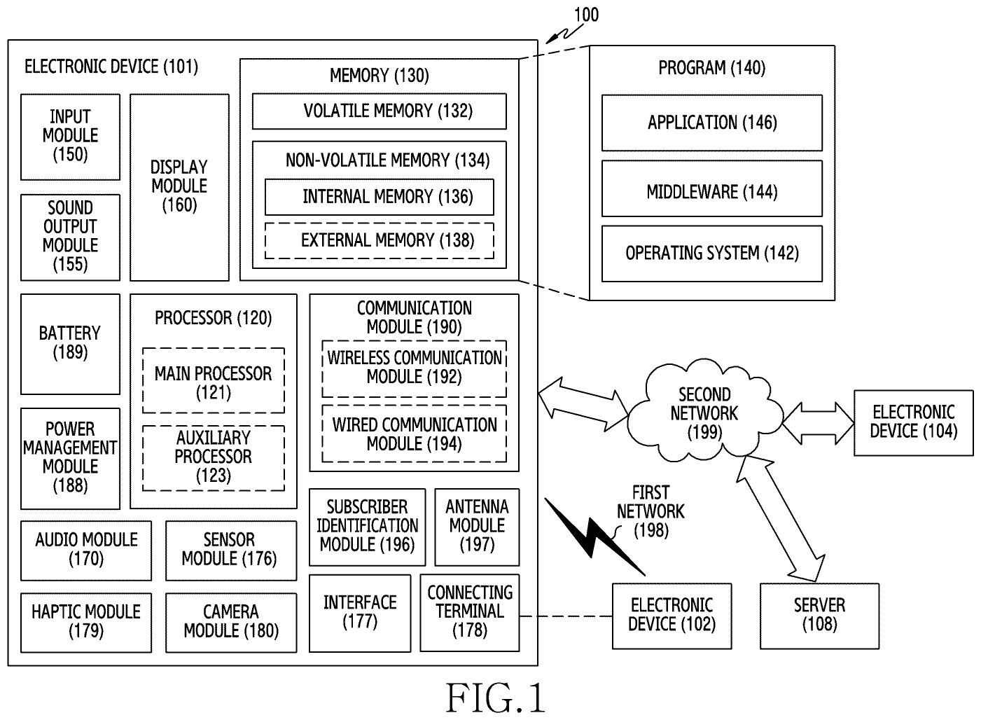

FIG. 1 is a block diagram illustrating an electronic device in a network environment according to an embodiment of the disclosure.

Referring to FIG. 1, an electronic device 101 in a network environment 100 may communicate with an external electronic device 102 via a first network 198 (e.g., a short-range wireless communication network), or at least one of an external electronic device 104 or a server 108 via a second network 199 (e.g., a long-range wireless communication network). According to an embodiment of the disclosure, the electronic device 101 may communicate with the external electronic device 104 via the server 108. According to an embodiment of the disclosure, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments of the disclosure, at least one of the components (e.g., the connecting terminal 178) may be omitted from the electronic device 101, or one or more other components may be added in the electronic device 101. In some embodiments of the disclosure, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment of the disclosure, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment of the disclosure, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., a sleep) state, or together with the main processor 121 while the main processor 121 is in an active state (e.g., executing an application). According to an embodiment of the disclosure, the auxiliary processor 123 (e.g., an image signal processor or a communication processor) may be implemented as part of another component (e.g., the camera module 180 or the communication module 190) functionally related to the auxiliary processor 123. According to an embodiment of the disclosure, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment of the disclosure, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment of the disclosure, the display module 160 may include a touch sensor adapted to detect a touch, or a pressure sensor adapted to measure the intensity of force incurred by the touch.

The audio module 170 may convert a sound into an electrical signal and vice versa. According to an embodiment of the disclosure, the audio module 170 may obtain the sound via the input module 150, or output the sound via the sound output module 155 or a headphone of an external electronic device (e.g., the external electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment of the disclosure, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the external electronic device 102) directly (e.g., wiredly) or wirelessly. According to an embodiment of the disclosure, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the external electronic device 102). According to an embodiment of the disclosure, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment of the disclosure, the haptic module 179 may include, for example, a motor, a piezoelectric element, or an electric stimulator.

The camera module 180 may capture a still image or moving images. According to an embodiment of the disclosure, the camera module 180 may include one or more lenses, image sensors, image signal processors, or flashes.

The power management module 188 may manage power supplied to the electronic device 101. According to one embodiment of the disclosure, the power management module 188 may be implemented as at least part of, for example, a power management integrated circuit (PMIC).

The battery 189 may supply power to at least one component of the electronic device 101. According to an embodiment of the disclosure, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the external electronic device 102, the external electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment of the disclosure, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the external electronic device 104), or a network system (e.g., the second network 199). According to an embodiment of the disclosure, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment of the disclosure, the antenna module 197 may include an antenna including a radiating element including a conductive material or a conductive pattern formed in or on a substrate (e.g., a printed circuit board (PCB)). According to an embodiment of the disclosure, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment of the disclosure, another component (e.g., a radio frequency integrated circuit (RFIC)) other than the radiating element may be additionally formed as part of the antenna module 197.

According to various embodiments of the disclosure, the antenna module 197 may form a mmWave antenna module. According to an embodiment of the disclosure, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment of the disclosure, commands or data may be transmitted or received between the electronic device 101 and the external electronic device 104 via the server 108 coupled with the second network 199. Each of the external electronic devices 102 or 104 may be a device of a same type as, or a different type, from the electronic device 101. According to an embodiment of the disclosure, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment of the disclosure, the external electronic device 104 may include an internet-of-things (IoT) device. The server 108 may be an intelligent server using machine learning and/or a neural network. According to an embodiment of the disclosure, the external electronic device 104 or the server 108 may be included in the second network 199. The electronic device 101 may be applied to intelligent services (e.g., a smart home, a smart city, a smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment of the disclosure, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment of the disclosure, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments of the disclosure, each component (e.g., a module or a program) of the above-described components may include a single entity or multiple entities, and some of the multiple entities may be separately disposed in different components. According to various embodiments of the disclosure, one or more of the above-described components may be omitted, or one or more other components may be added. Alternatively or additionally, a plurality of components (e.g., modules or programs) may be integrated into a single component. In such a case, according to various embodiments of the disclosure, the integrated component may still perform one or more functions of each of the plurality of components in the same or similar manner as they are performed by a corresponding one of the plurality of components before the integration. According to various embodiments of the disclosure, operations performed by the module, the program, or another component may be carried out sequentially, in parallel, repeatedly, or heuristically, or one or more of the operations may be executed in a different order or omitted, or one or more other operations may be added.

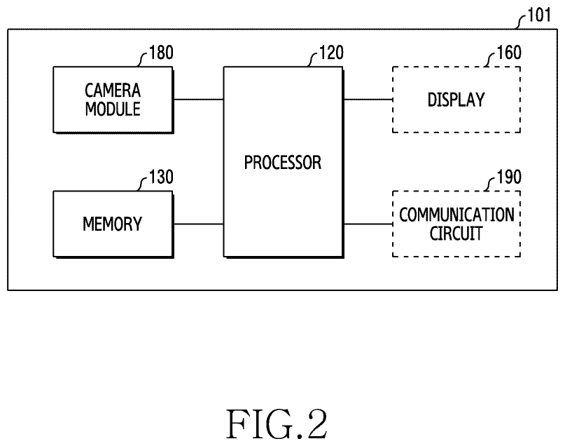

FIG. 2 is a block diagram for an electronic device according to an embodiment of the disclosure.

Referring to FIG. 2, the electronic device 101 according to an embodiment may include a camera module 180, memory 130, and at least one processor 120. The electronic device 101 according to an embodiment may further include at least one of a display or a communication circuit 190. However, the components of the electronic device 101 of FIG. 2 are intended to explain an embodiment of the disclosure, and the electronic device 101 may include more components than the components of FIG. 2, or may include other components which may replace at least some of the components. For example, the memory 130 is not limited to a storage medium included in the electronic device 101, and may include a cloud storage outside the electronic device 101.

According to an embodiment of the disclosure, the at least one processor may execute instructions stored in the memory 130. The at least one processor 120 may execute an application related to an operation of a camera included in the camera module 180. The application related to the operation of the camera may include, for example, an application which provides a function of displaying through the display module 160 a preview image for an image to be captured based on at least one image stream obtained through the camera. The application related to the operation of the camera may include an application which provides a function of creating a file obtained by capturing a still image or a moving image. For example, the application related to the operation of the camera may include an application which provides a video telephony function, based on an image obtained through the camera. However, a type of the application is not limited thereto. For example, the application related to the camera may include an application which captures a still image and/or a moving image. For example, the application related to the camera may include an application which streams an image to be captured to an external device on a real-time basis. For example, the application related to the camera may include an application (e.g., a QR code scanner, a barcode scanner, a product search application, or an optical character recognition application) which provides a user with information by analyzing a captured image. For example, the application related to the camera may include an application which controls an operation of the electronic device through image analysis (e.g., an application which controls brightness of a display by determining illumination information). The aforementioned examples are intended to describe examples of specific embodiments of the disclosure, and the disclosure is not limited thereto.

According to an embodiment of the disclosure, the at least one processor 120 may further execute a different client distinct from the application related to the operation of the camera. In the disclosure, the application related to the operation of the camera may refer to a program which is executed by occupying the camera, and the client may refer to a program which receives a surface injection service to provide a function using the camera. The different client may be a program which provides a service by using an image obtained through the camera. For example, the different client may include at least one a remote watch client which provides a function of mirroring a preview image to an external electronic device (e.g., a wearable device), a motion photo client which provides a function of simultaneously capturing a still image and a moving image, or a single take client which creates a plurality of still images or moving images, based on an image frame captured during a specified time interval. However, a type of the client is not limited thereto. The client may include a program which provide a function provided by using the still image or moving image obtained through the camera (e.g., a function which provides content, such as a RAW image file, an image file applied with a filter, or an image file applied with an image effect, or a function of sharing an image to be streamed).

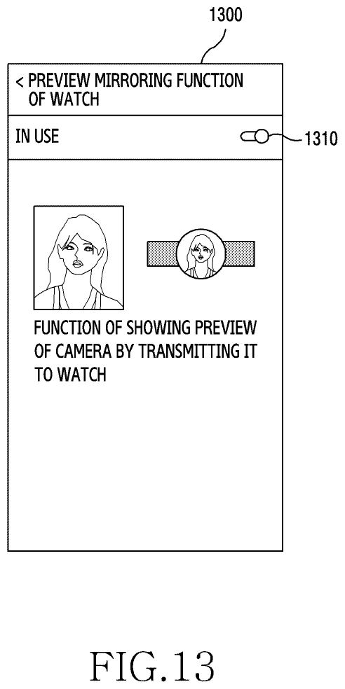

According to an embodiment of the disclosure, the at least one processor 120 may allow the executed application to occupy the camera included in the camera module 180. The at least one processor 120 may initiate the operation of the camera, based on a configuration of at least one image stream requested by the executed application so that the executed application occupies and uses the camera. In the disclosure, the image stream may be referred to as a collection of buffer queues for carrying images either intermittently or continuously, by specifying a feature (e.g., an image format or a size) of an image to be stored in a buffer. The at least one processor 120 may decide whether to provide at least one image stream to a different client other than the executed application. For example, based on that the application using the camera is called, the at least one processor 120 may control the display module 160 to display an execution screen (e.g., a screen 1300 of FIG. 13) of an application or service which manages the different client according to the configuration of the at least one image stream requested by the called application. In an embodiment of the disclosure, the at least one processor 120 may decide whether to configure the image stream, based on the decision that the scaling operation is not necessary to provide image data obtained through the camera module 180 to the executed application or the different client, based on a value set by a user input for the displayed execution screen.

In an embodiment of the disclosure, according to whether to configure the image stream based on the decision that the scaling operation is not necessary to provide it to the executed application and the different client, the at least one processor 120 may determine the configuration of the image stream to be created through the camera in a process of initiating the operation of the camera. For example, the at least one processor 120 may change at least one of a type (e.g., a format or a size) or count of at least one image stream. The configuration of the image stream may refer to, for example, at least one of a type (e.g., an image format (e.g., a JPEG format, an NV21 format) or a resolution (or a size)) or count for each of at least one image stream obtained through the camera, based on a capture request generated by the executed application. The at least one processor 120 may determine the configuration of the image stream, and may obtain image data corresponding to the determined configuration of the image stream. For example, when a configuration is determined based on the decision that the scaling operation for one or more image streams including an image stream corresponding to the JPEG format and a resolution of 4000×3000 and an image stream corresponding to the NV21 format and a resolution of 2440×1440 (e.g., when an image is providable without alteration of a resolution or a size), the at least one processor 120 may adjust a configuration for the operation of the camera to obtain the image data including the image frame corresponding to the JPEG format and the resolution of 4000×3000 and the image frame corresponding to the NV21 format and the resolution of 2440×1440.

According to an embodiment of the disclosure, the at least one processor 120 may determine a configuration of an image stream, based on information on image streams supportable in relation to the camera included in the camera module 180. The at least one processor 120 may configure or re-configure at least one image stream obtained through the camera in response to a request generated by the executed application. The at least one processor 120 may configure or re-configure the image stream, based on the determined configuration.

In an embodiment of the disclosure, while the application which occupies or uses the camera of the camera module 180 is executed in foreground, the at least one processor 120 may execute a program (e.g., a surface injector) for injecting at least one image stream requested by a client (a client distinct from the application which occupies or uses the camera) to the configuration of the image stream obtained through the camera. In the disclosure, the at least one image stream requested by the client may be referred to as a surface.

In an embodiment of the disclosure, the at least one processor 120 may determine a configuration of an image stream to be configured based on at least one of first information on supportable image streams, second information on at least one first image stream requested by the application which occupies or uses the camera, or third information on at least one second image stream (surface) requested by the different client. The first information on the supportable image stream may include information on a configuration of image stream which may be provided by the electronic device 101 through the camera. For example, the first information may include information on at least one of the number of image streams supportable at the same time, an image format of the image stream, an image size, a resolution, a data space, and a stream usage.

In an embodiment of the disclosure, the at least one processor 120 may include whether the configuration of the supportable image streams included in the first information is able to accommodate both at least one first image stream requested by the application which occupies or uses the camera and at least one second image stream requested by the different client. For example, when four image streams are supportable, the application which occupies or uses the camera requires two image streams, and the different client requires two image streams, the at least one processor 120 may determine the configuration of the image stream in which surfaces (image streams) requested by the different client are added to the image streams requested by the application which occupies or uses the camera.

In an embodiment of the disclosure, the at least one processor 120 may decide whether at least one image stream requested by the application which occupies or uses the camera includes a stream of the same type as at least one image stream included in a surface requested in the different client. Whether it is the same-type stream may refer to whether the stream requested by the application is a type of a stream which is usable by being shared by the different client. For example, whether it is the same-type stream may refer to whether one shared stream and another shared stream have the same image format and resolution (or size).

In an embodiment of the disclosure, when at least one image stream requested by the application which occupies or uses the camera includes a stream of the same type as at least one of the one or more image streams included in the surface requested by the different client, the at least one processor 120 may configure the identified same-type stream as a shared stream to decide whether it is possible to determine a configuration of an image stream in which the surface is injected. For example, the number of supportable image streams may be 4, the application which occupies or uses the camera may require three image streams, and the different client may require two image streams. When two image streams out of the image streams requested by the application which occupies or uses the camera are the same-type streams, two image streams out of the three image streams requested by the application which occupies or uses the camera may be configured as shared streams to determine a hardware configuration of the electronic device 101 or the configuration of the image stream in a range supportable on an operating system.

In an embodiment of the disclosure, the at least one processor 120 may decide whether a replacement surface is available. For example, when first information indicates that four image streams are supportable and the application which occupies or uses the camera uses four image streams, an image stream corresponding to the replacement surface is not addable. In this case, the at least one processor 120 may decide that the replacement surface is unavailable. However, a condition of deciding whether the replacement surface is available may be determined variously, and the disclosure is not limited thereto. When the replacement surface is unavailable, the at least one processor 120 may configure at least one image stream without having to add the surface. For example, when the first information indicates that four image streams are supportable and the application which occupies or uses the camera uses three image streams, the least one processor 120 may decide that the replacement surface is available. When the replacement surface is available, the at least one processor 120 may determine a configuration of an image stream including the replacement stream.

In an embodiment of the disclosure, the at least one processor 120 may initiate the operation of the camera included in the camera module 180 so that at least one image stream is providable according to the determined configuration of the image stream. The at least one processor 120 may obtain at least one first image stream from image data obtained in response to a capture request generated in the application and provide it to the application which occupies or uses the camera, and may obtain at least one second image stream from the image data and provide it to the different client. For example, when the different client is for a service which mirrors a preview image for camera shooting to an external electronic device, the at least one processor 120 may transmit the at least one second image stream to the external electronic device through the communication circuit 190.

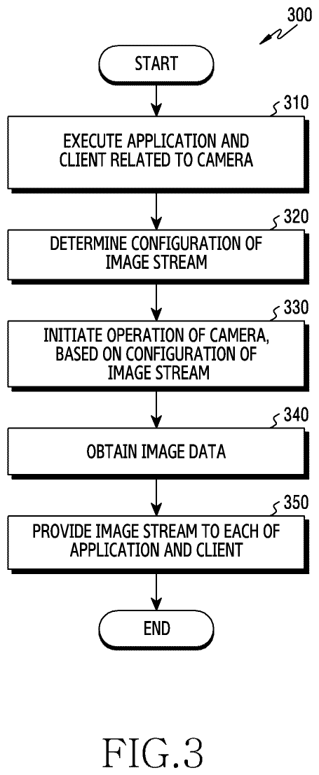

FIG. 3 is a flowchart 300 illustrating a process in which an electronic device provides at least one image stream to a client according to an embodiment of the disclosure.

Referring to FIG. 3, it may be understood that an operation of the electronic device 101 is performed when at least one processor (e.g., the at least one processor 120 of FIG. 2) performs an operation or controls a component of the electronic device 101.

According to an embodiment of the disclosure, in operation 310, the electronic device 101 may execute an application related to a camera (e.g., the camera module 180 of FIG. 1, the camera module 180 of FIG. 2). The application related to the camera may refer to a program which provides a service, based on image data obtained by occupying or using the camera. The electronic device 101 may execute a client related to the camera (e.g., the camera module 180 of FIG. 1, the camera module 180 of FIG. 2). The client related to the camera may refer to a program which provides a service, based on image data obtained through the camera.

According to an embodiment of the disclosure, in operation 320, the electronic device 101 may determine a configuration of an image stream to be obtained through the camera. In an embodiment of the disclosure, the electronic device 101 may determine the configuration of the image stream, based on information on image streams supportable in relation to the camera. For example, the electronic device 101 may decide whether a surface requested by a different client is addable to at least one image stream requested by an application which occupies or uses the camera, based on information on the supportable image streams. The electronic device 101 may determine the configuration of the image stream, based on a result of the decision. For example, the electronic device 101 may determine a configuration in which at least one second image stream corresponding to the surface requested by the different client is added to at least one first image stream requested by the application which occupies or uses the camera. For example, the electronic device 101 may determine the configuration of the image stream in which at least part of the at least one first image stream requested by the application which occupies or uses the camera is configured as a shared stream. For example, the electronic device 101 may determine the configuration of the image stream, in which a replacement stream for replacing the at least one second image stream corresponding to the surface requested by the different client is added to the at least one first image stream requested by the application which occupies or uses the camera. For example, the electronic device 101 may determine the configuration of the image stream maintained without alteration of the at least one first image stream requested by the application which occupies or uses the camera.

In operation 330, the electronic device 101 may initiate an operation of the camera, based on the determined configuration of the image stream. In an embodiment of the disclosure, the electronic device 101 may control the camera module 180 to prepare for the operation of the camera, based on the configuration of the image stream determined in the operation 320. For example, the electronic device 101 may set parameters related to the operation of the camera so that at least one image stream is output based on a resolution and image format of image streams included in the configuration of the image stream through the camera.

In operation 340, the electronic device 101 may obtain image data. In an embodiment of the disclosure, the electronic device 101 may obtain image data corresponding to a configuration of an image stream determined through the camera, based on a request of an application executed to occupy or use the camera. The electronic device 101 according to an embodiment may store the obtained image data in a buffer allocated to memory (e.g., the memory 130 of FIG. 1, the memory 130 of FIG. 2).

In operation 350, the electronic device 101 may provide the image stream to each of the application and the client, based on the obtained image data. For example, the application executed to occupy or use the camera may access the buffer having the image data stored therein to obtain at least one first image stream requested by the application. A different client may access the buffer to obtain at least one second image stream requested by the different client from the image data.

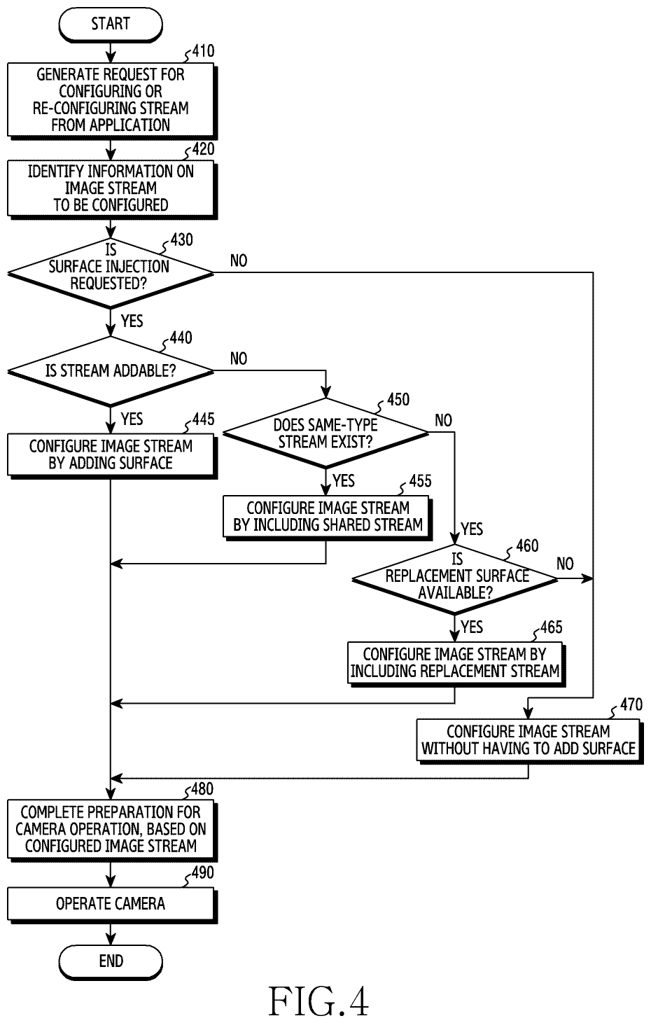

FIG. 4 is a flowchart 400 illustrating a process in which an electronic device determines an image stream and initiates an operation of a camera according to an embodiment of the disclosure. For example, operations of the flowchart 400 may be performed in the operations 310 and 320 of FIG. 3.

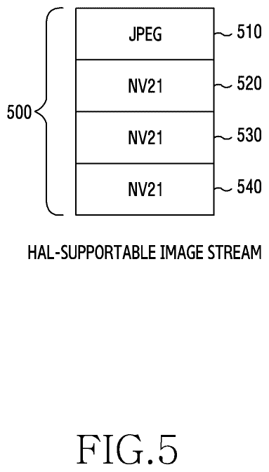

FIG. 5 illustrates an electronic device configuring an image stream supportable for a camera according to an embodiment of the disclosure.

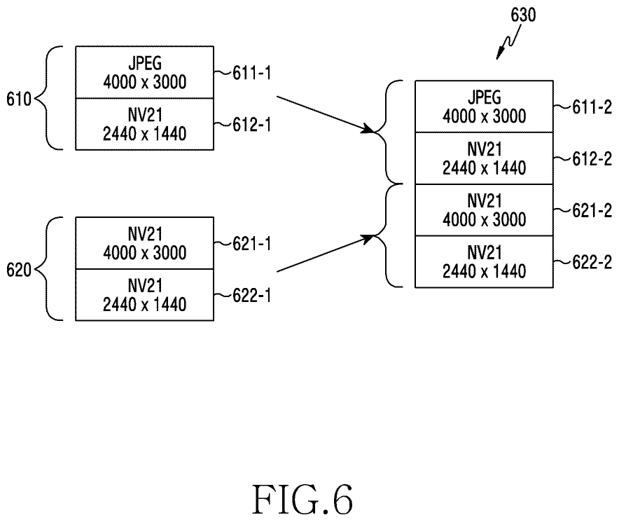

FIG. 6 illustrates an electronic device configuring at least one image stream by adding a surface when a stream is addable according to an embodiment of the disclosure.

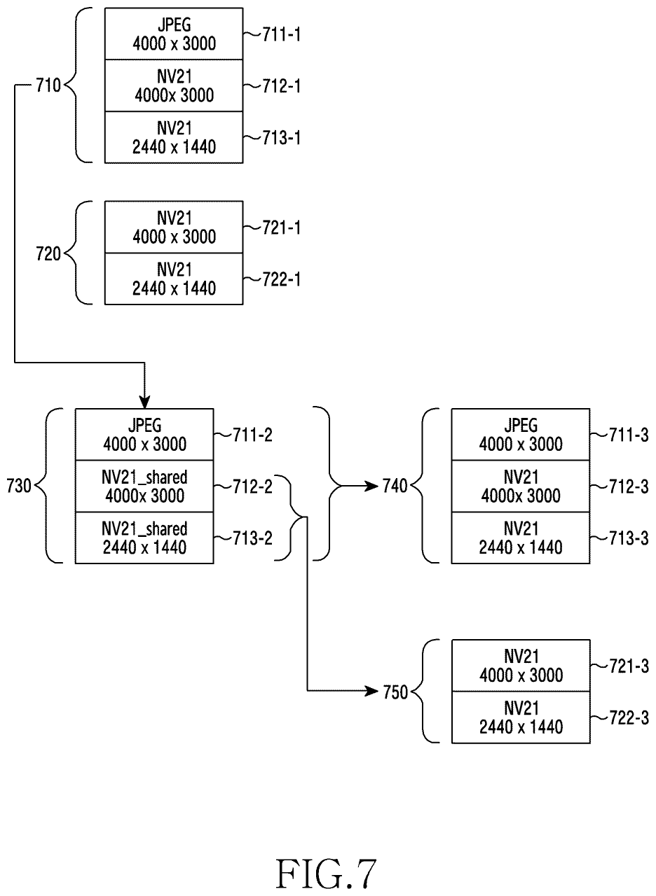

FIG. 7 illustrates an electronic device configuring at least one image stream by including a shared stream according to an embodiment of the disclosure.

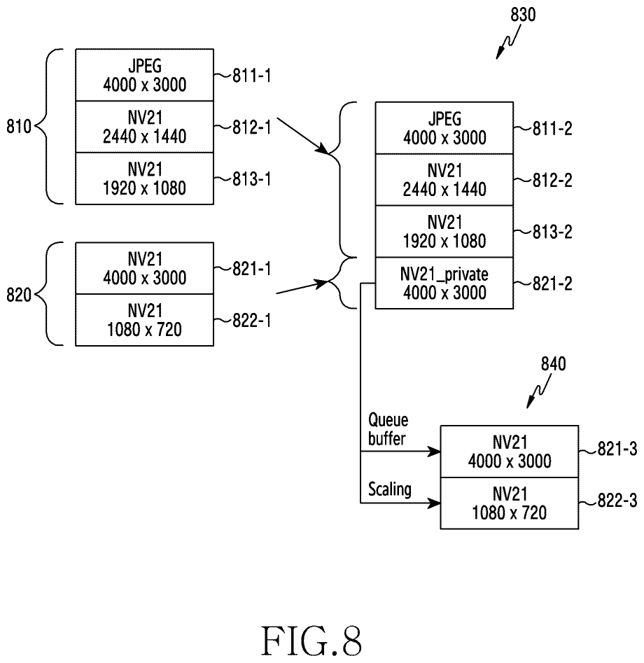

FIG. 8 illustrates an electronic device configuring at least one image stream by including a replacement stream according to an embodiment of the disclosure.

Referring to FIG. 4, in operation 410, a request for configuring or re-configuring a stream may be generated from an application executed by the electronic device 101 according to an embodiment. For example, the electronic device 101 may execute a camera application, based on a user input for selecting the camera application from a list of applications installed in the electronic device 101. The camera application may generate a request for configuring or re-configuring at least one image stream output from the camera to use the camera.

In operation 420, the electronic device 101 may verify information on at least one image stream to be configured. For example, a request for initiating the driving of the camera may be generated by the executed application related to the camera. The electronic device 101 may verify information on at least one first image stream included in the request. For example, the electronic device 101 may identify information on at least one of an image format or resolution (size) for each of the one or more first image streams.

In operation 430, the electronic device 101 according to an embodiment may decide whether it is a state where surface injection is requested from the different client. For example, the electronic device 101 may decide that it is the state where the surface injection is requested from the client which provides a preview mirroring function when the mirroring function is enabled based on a toggle button 1310 included in a user interface of FIG. 13. Based on the decision that it is not the state where the surface injection is requested from the different client, in operation 470, the electronic device 101 may configure at least one image stream without having to add a surface.

In an embodiment of the disclosure, based on the decision that the surface injection is requested from the different client, in operation 440, the electronic device 101 may decide whether an image stream is addable. The electronic device 101 may decide whether at least one second image stream is addable, corresponding to a surface requested to be injected to at least one first image stream requested by an application which occupies or uses the camera. The electronic device 101 may decide whether the image stream is addable based on at least one of first information on image streams supportable in relation to the camera, second information on at least one first image stream requested by the application which occupies or uses the camera, or third information on at least one second image stream requested by the different client. The second information may include at least one of information on an image format, information about a resolution, an image size, a resolution, a data space, or a stream usage of each of the at least one first image stream. The third information may include at least one of information on an image format, information about a resolution, an image size, a resolution, a data space, or a stream usage of each of the at least one second image stream.

Referring to FIG. 5, an example for a configuration of image streams 500 supportable in a camera HAL is illustrated. The total number of image streams 500 provided in the example of FIG. 5 is 4. According to the example of FIG. 5 illustrating the supportable streams 500 of FIG. 5, the electronic device 101 may support an image stream 510 of an image format of Joint Photographic Expert Group (JPEG) and three image streams 520, 530, and 540 of an image format of NV21 through a camera.

Referring to FIG. 6, in the illustrated example, at least one image stream is configured according to a configuration of an image stream added with a surface in the operations 440 and 445, based on the supportable image streams 500 of FIG. 5. FIG. 6 illustrates a case where an application which occupies or uses a camera requires at least one first image stream 610, and a different client requires at least one second image stream 620. Referring to FIG. 6, the at least one first image stream 610 may include two image streams 611-1 and 612-1. The image stream 611-1 may have a resolution of 4000×3000 and the image format of JPEG. The image stream 612-1 may have a resolution of 2440×1400 and the image format of NV21. Referring to FIG. 6, the at least one second image stream 620 may include two image streams 621-1 and 622-1. The image stream 621-1 may have a resolution of 4000×3000 and the image format of NV21. The image stream 622-1 may have a resolution of 2440×1440 and the image format of NV21. Since two more image streams having the image format of NV21 may be further added even if the at least one image stream 610 is included in the supportable image streams 500, the electronic device 101 may decide in the operation 440 that at least one second image stream may be added. In this case, the electronic device 101 may determine in the operation 445 that at least one image stream is configured based on a configuration 630 of an image stream to which the at least second image stream 620 is added. The determined configuration 630 of the image stream may include image streams 611-2 and 612-3 included in the at least one first image stream 610 and image streams 621-2 and 622-2 included in the at least one second image stream 620.

The electronic device 101 according to an embodiment may decide in the operation 440 that the image stream is not addable based on at least one of first information, second information, or third information. For example, when at least one image stream corresponding to a surface requested for injection by the different client is not configurable based on the remaining image streams other than an image stream used by at least one first image stream of the application which occupies or uses the camera among the supportable image streams, the electronic device 101 may decide that the image steam is not addable.

Based on the decision that the image stream is not addable, in operation 450, the electronic device 101 according to an embodiment may decide whether at least one first image stream and at least one second image stream include a same-type stream. For example, the electronic device may compare at least one of an image format or resolution of each of at least one first image stream and at least one an image format or resolution of each of at least one second image stream.

In an embodiment of the disclosure, based on the decision that the at least one first image stream and the at least one second image stream include the same-type stream, the electronic device 101 may decide whether image streams are configurable based on a configuration of an image stream including a shared stream. In operation 455, for example, in a state where the number of supportable image streams is 4 and three image streams are requested as the at least one first image stream and two image streams are requested as the at least one second image stream, when any one of the first image streams and any one of the second image streams have the same image format and the same resolution, the electronic device 101 may configure the image stream of the same type as the shared stream of the application and the different client, and may determine a configuration of an image stream added with the remaining one of the second image streams.

FIG. 7 illustrates a case where an application which occupies or uses a camera requires at least one first image stream, and a different client requires at least one second image stream according to an embodiment of the disclosure.

Referring to FIG. 7, at least one first image stream 710 may include an image stream 711-1 having a resolution of 4000×3000 and an image format of JPEG, an image stream 712-1 having the resolution of 4000×3000 and an image format of NV21, and an image stream 713-1 having a resolution of 2440×1440 and the image format of NV21. At least one second image stream 720 may include an image stream 721-1 having the resolution of 4000×3000 and the image format of NV21 and an image stream 722-1 having the resolution of 2400×1440 and the image format of NV21. The electronic device 101 may decide whether the same-type stream is included based on at least one of second information on the at least one first image stream 710 requested by the application which occupies or uses the camera or third information on the at least one second image stream 720 requested by the different client. For example, the electronic device 101 may decide that the image stream 712-1 and the image stream 721-1 have the same resolution and the same image format and thus are the same-type image streams. For example, the electronic device 101 may determine that the image stream 713-1 and the image stream 722-1 are the same-type image streams. Based on a result of the decision, the electronic device 101 may determine a configuration 730 of an image stream included as a shared stream which allows an image stream 712-2 and an image stream 713-2 to be provided together to the different client and the application which occupies and uses the camera. The electronic device 101 may provide at least one first image stream 740 including image streams 721-3 and 722-3 to the application which occupies or uses the camera, based on the image streams 711-2, 712-2, and 713-2. The electronic device 101 may provide at least one second image stream 750 including the image streams 721-3 and 722-3 to the different client, based on the shared image streams 712-2 and 713-2.

Based on the decision in the operation 450 that the at least one first image stream and the at least one second image stream do not include the same-type stream, in operation 460, the electronic device 101 according to an embodiment may decide whether a replacement surface is available. The replacement surface may refer to an image stream provided in replacement with at least one of the one or more second streams to provide the at least one second image stream. The image stream provided in replacement with the at least one of the one or more second streams may be referred to as a replacement stream. Based on the decision that the replacement surface is available, in operation 465, the electronic device 101 according to an embodiment may configure an image stream, based on a configuration of an image stream including the replacement stream. The electronic device 101 may use a replacement surface which replaces at least one of the one or more first image streams to provide the at least one first image stream. For example, when the at least one first image stream includes image streams which use four different resolutions and the at least one second image stream includes image streams which use three different resolutions without a resolution common to the at least one first image stream, one image stream may be configured as a replacement surface, and an image obtained from the replacement surface may be resized to obtain at least one first image stream and at least one second image stream.

Based on the decision that the replacement surface is unavailable, in operation 470, the electronic device 101 according to an embodiment may configure at least one image stream without having to add the surface. For example, when a rule defining a case where the replacement surface is unavailable based on a specified condition (e.g., a performance condition of the electronic device 101), the electronic device 101 may configure at least one image stream without having to add the surface, based on the decision that the specified condition is satisfied. In the operation 470, the electronic device 101 according to an embodiment may transfer to a client a dialog which notifies that the image stream is unavailable.

FIG. 8 illustrates a case where an application which occupies or uses a camera requires at least one image stream, and a different client requires at least one second image stream according to an embodiment of the disclosure.

Referring to FIG. 8, at least one first image stream 810 may include an image stream 811-1 of a resolution of 4000×3000 and an image format of JPEG, an image stream 812-1 having a resolution of 2440×1440 and an image format of NV21, and an image stream 813-1 having a resolution of 1920×1080 and the image format of NV 21. At least one second image stream 820 may include an image stream 821-1 having the resolution of 4000×3000 and the NV21 format, and an image stream 822-1 having a resolution of 1080×720 and the NV21 format. Comparing first information on the supportable image streams 500 of FIG. 5 and second information on the at least one first image stream 810 requested by an application, since one more image stream of the image format of NV21 may be further added, the electronic device 101 may determine a configuration 830 of an image stream in which a replacement stream 821-2 is added to image streams 811-2, 812-2, and 813-2 corresponding to the second information. The replacement stream 821-2 may be configured to satisfy the configuration of the supportable image streams 500. In an embodiment of the disclosure, the electronic device 101 may provide at least one second image stream 840 to the different client by performing at least one image processing operation on the replacement stream 821-2. The electronic device 101 may decide whether to perform the at least one image processing operation by comparing an attribute of the replacement stream 821-2 and an attribute of the image streams 821-1 and 822-1 included in the at least one second image stream 820 included in the third information. For example, since the image stream 821-1 and the replacement stream 821-2 have the same attribute, the electronic device 101 may obtain an image stream 821-3 to be included in the at least one second image stream 840 by queueing the image stream 821-2 stored in a buffer. Since the image stream 822-1 has a lower resolution than the replacement stream 821-2, the electronic device 101 may obtain an image stream 822-3 by down scaling the replacement stream 821-2. The electronic device 101 may provide the different client with the at least one second image stream 840 including the image streams 821-3 and 822-3.

In operation 480, the electronic device 101 according to an embodiment may prepare the operation of the camera, based on the configuration of the image stream configured based on the operation 445, 455, 465 or 470. Based on completion of the operation of preparing the camera in the operation 480, the electronic device 101 may initiate the operation of the camera in operation 490.

However, FIG. 4 is for explaining a method in which the electronic device 101 according to an embodiment determines a configuration of an image stream, based on information on a configuration of supportable image streams. A specific method in which a configuration of an image stream is determined within the configuration of the supportable image streams may be modified. For example, although it is illustrated in FIG. 4 that the respective decision operations based on the operations 440, 450, and 460 are performed sequentially, the operations may be implemented as a single operation of selecting whether to determine a configuration of an image stream, based on at least one of the operations 445, 455, 465, and 475, instead of the sequential decisions illustrated in FIG. 4.

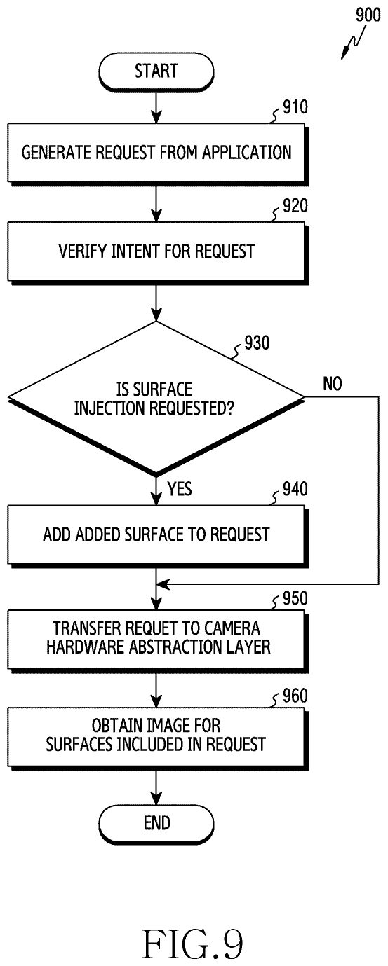

FIG. 9 is a flowchart 900 illustrating a process in which an electronic device obtains image data according to an embodiment of the disclosure. The process of FIG. 9 may be performed based on a request of an application in a state where an operation of a camera is initiated (e.g., the flowchart of FIG. 4).

Referring to FIG. 9, in operation 910, a request may be generated from an application executed by the electronic device 101 according to an embodiment. The request generated from the executed application may be a request for capturing or streaming image data through the camera. The electronic device 101 according to an embodiment may identify a surface required at the generated request.

In operation 920, the electronic device 101 according to an embodiment may identify an intent of the generated request. The intent of the request may be related to an operation required to be performed at the request. For example, the electronic device 101 may decide whether the intent of the request is for displaying a preview image or for capturing a still image.

In operation 930, the electronic device 101 according to an embodiment may decide whether a different client corresponds to an intent of requesting surface injection. Based on the decision that the different client corresponds to the intent of requesting the surface injection, in operation 940, the electronic device 101 may add an added surface to a request for the camera. Upon deciding that the different clint does not correspond to the intent for requesting the surface injection, the operation 940 may be skipped.

In operation 950, the electronic device 101 according to an embodiment may transfer a request for obtaining image data to a HAL. In operation 960, the electronic device 101 according to an embodiment may obtain image data for surfaces included in the request through the camera.

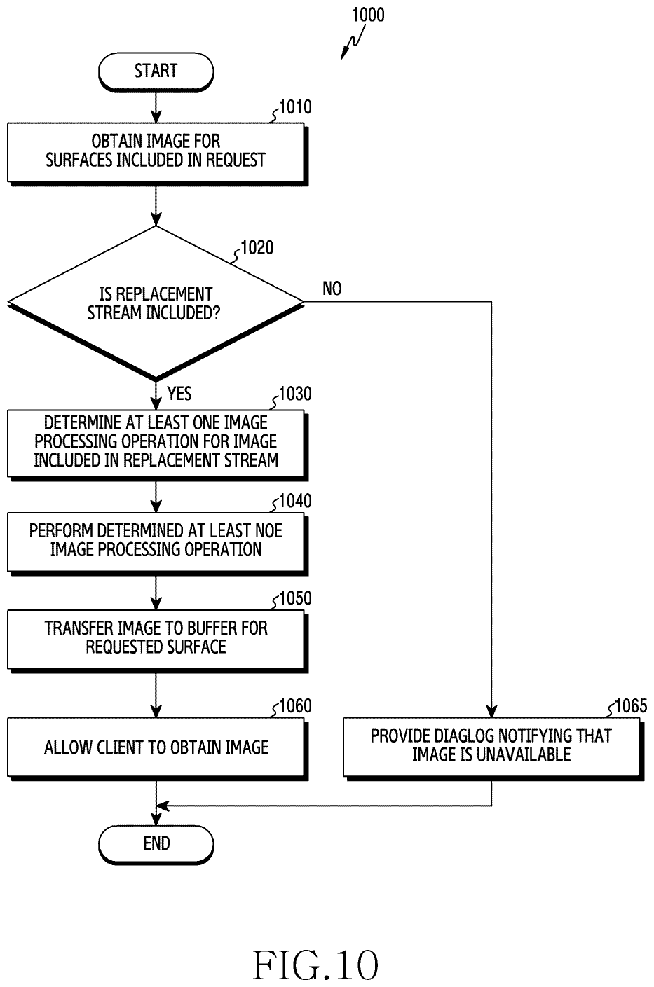

FIG. 10 is a flowchart 1000 illustrating a process in which an electronic device transfers an image to a client, based on image data obtained by the electronic device according to an embodiment of the disclosure.

Referring to FIG. 10, in operation 1010, the electronic device 101 according to an embodiment may perform an operation (e.g., the operation 960 of FIG. 9) of obtaining image data for surfaces included in a request through a camera. In an embodiment of the disclosure, the electronic device 101 may store image data including at least one image stream obtained through the camera in a buffer allocated to memory (e.g., the memory 130 of FIG. 2, the memory 130 of FIG. 2), and may obtain the image data stored in the buffer.

In operation 1020, the electronic device 101 may decide whether the obtained image data includes a replacement stream. For example, when the electronic device 101 drives the camera, based on a configuration of an image stream determined based on the operation 465 of FIG. 4, the electronic device 101 may decide that the obtained image data includes the replacement stream. However, the operation 1020 is not limited to the aforementioned example. When the obtained image data does not include the replacement stream, in operation 1065, the electronic device 101 may notify that the image stream is not providable to the client. For example, the electronic device 101 may provide the client with a dialog notifying that an image is unavailable.

In an embodiment of the disclosure, when the obtained image data includes the replacement stream, in operation 1030, the electronic device 101 may determine at least one image processing operation for an image included in the replacement stream. In an embodiment of the disclosure, the electronic device 101 may compare an attribute of the replacement stream and an attribute of each of at least one second image stream requested by the client. For example, the attribute of the replacement stream and each of the at least one second image stream may include at least one an image resolution or an image format. In the operation 1030, the electronic device 101 according to an embodiment may determine at least one image processing operation for obtaining an image corresponding to the attribute of the at least one second image stream from the replacement stream, based on a result of the comparison.

In operation 1040, the electronic device 101 according to an embodiment may perform the at least one image processing operation determined in the operation 1030. The electronic device 101 according to an embodiment may obtain an image corresponding to the attribute of the at least one second image stream through the at least one image processing operation. For example, the at least one image processing operation may refer to an operation of converting the attribute of the replacement stream to correspond to an attribute of at least one of the one or more second image streams requested by the client. For example, the at least one image processing operation may include at least one of an operation of cropping image data included in the replacement stream, an operation of performing scaling, or an operation of converting an image format.

In operation 1050, the electronic device 101 according to an embodiment may transfer at least one image stream obtained through the at least one image processing operation to a buffer for a surface requested from the client. In operation 1060, the electronic device 101 according to an embodiment may allow the client which has requested the surface to obtain an image from the buffer.

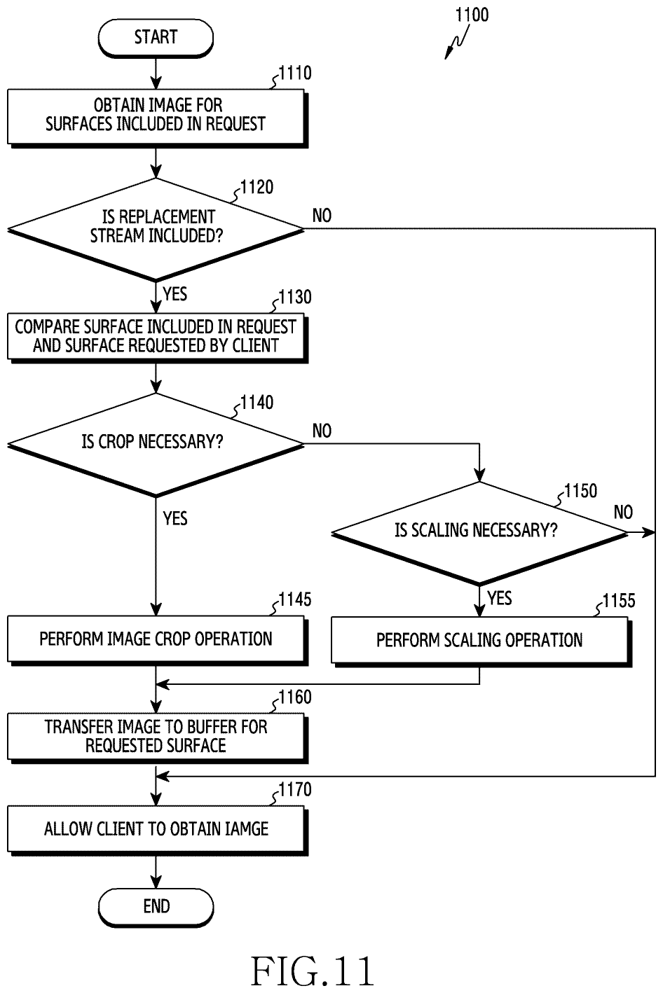

FIG. 11 is a flowchart 1100 illustrating a process in which an electronic device transfers an image to a client, based on whether at least one image stream is configured by including a replacement stream according to an embodiment of the disclosure.

Referring to FIG. 11, since operations 1110 and 1120 of the process illustrated in the flowchart 1100 of FIG. 11 may be configured identically in practice to the operations 1010 and 1020 of FIG. 10, detailed descriptions thereof will be omitted.

In operation 1130, the electronic device 101 according to an embodiment may compare an attribute of an image obtained for a surface included in a request and an attribute of an image included in a surface requested by the client. For example, the electronic device 101 may compare a resolution (or a size) of images.

In operation 1140, the electronic device 101 according to an embodiment may decide whether an operation of cropping an image is necessary, based on a result of the comparison. For example, when an aspect ratio of the obtained image and an aspect ratio of the image requested from the client are different from each other, the electronic device 101 may decide that the crop operation is necessary. Based on the decision that the operation of cropping the image is necessary, in operation 1145, the electronic device 101 according to an embodiment may perform the operation of cropping the image.

Based on the decision that the operation of cropping the image is not necessary, in operation 1150, the electronic device 101 according to an embodiment may decide whether a scaling operation which enlarges or reduces the image is necessary. For example, when a size of the obtained image is greater than a size of the image requested from the client, the electronic device 101 may decide that a down-scaling operation which reduces the image is necessary. For example, when the size of the obtained image is smaller than the size of the requested image, the electronic device 101 may decide that an up-scaling operation which enlarges the image is necessary.

Based on the decision that the scaling operation is necessary, in operation 1155, the electronic device 101 according to an embodiment may perform the determined scaling operation. Based on the decision that the scaling operation is not necessary, in operation 1170, the electronic device 101 according to an embodiment may allow the client to obtain an image from a replacement stream.

In operation 1160, the electronic device 101 according to an embodiment may transfer at least one image stream obtained through an image processing operation to a buffer for a surface requested by the client. In an embodiment of the disclosure, the electronic device 101 may store image data obtained through the operation 1145 or 1155 in the buffer. In operation 1170, the electronic device 101 according to an embodiment may provide the client with an image stored in the buffer so that the client provides a service.

However, FIG. 11 is for explaining an example in which the electronic device 101 according to an embodiment provides at least one image stream to the client from the replacement stream, based on the crop operation or the scaling operation. A method for providing at least one image stream to the client from the replacement stream may be implemented variously. For example, although it is illustrated in FIG. 11 that any one of the operation 1145 and the operation 1155 is selectively performed, the image may be provided to the client by performing the operation 1145 and the operation 1155.

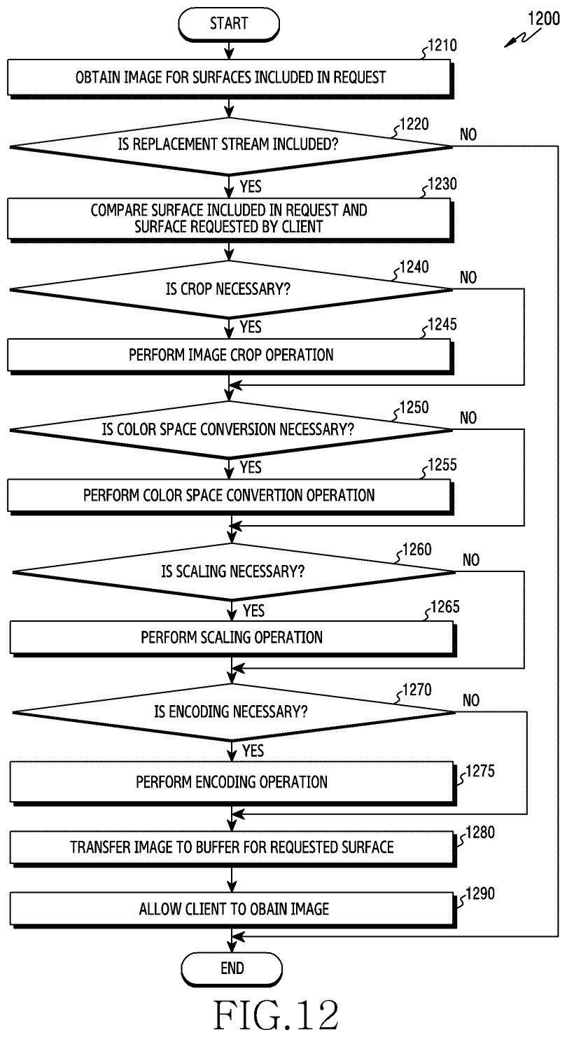

FIG. 12 is a flowchart 1200 illustrating a process in which an electronic device performs at least one image processing operation to transfer an image to a client according to an embodiment of the disclosure.

Referring to FIG. 12, since operations 1210 and 1220 of the process illustrated in the flowchart of FIG. 12 may be configured identically in practice to the operations 1010 and 1020 of FIG. 10, detailed descriptions thereof will be omitted.

In operation 1230, the electronic device 101 according to an embodiment may compare an attribute of an image obtained for a surface included in a request and an attribute of an image included in a surface requested by the client. For example, the electronic device 101 may compare at least one of a resolution (or a size), color space, or image format of images.

In operation 1240, the electronic device 101 according to an embodiment may decide whether an operation of cropping an image is necessary, based on a result of the comparison of the operation 1230. For example, when an aspect ratio of the obtained image and an aspect ratio of the image requested from the client are different from each other, the electronic device 101 may decide that the crop operation is necessary. When the aspect ratio of the obtained image corresponds to the aspect ratio of the image requested from the client, the electronic device 101 may decide that the crop operation is not necessary. Based on the decision that the operation of cropping the image is necessary, in operation 1245, the electronic device 101 according to an embodiment may perform the operation of cropping the image. In an example, based on the decision that the operation of cropping the image is not necessary, the operation 1245 may be skipped.

In operation 1250, the electronic device 101 according to an embodiment may decide whether color space conversion is necessary. For example, when a color space of an obtained image is a standard RGB color space and a color space of an image stream requested by the client is a YUV color space, the electronic device 101 may decide that an operation of converting the RGB color space to the YUV color space is necessary. When the color space of the obtained image is identical to the color space of the image stream requested by the client, the electronic device 101 may decide that the color space conversion operation is not necessary. Based on the decision that the color space conversion operation is necessary, in operation 1255, the electronic device 101 may perform the color space conversion operation which converts the color space of the image to the color space of the image stream requested by the client. In an example, based on the decision that the color space conversion operation is not necessary, the operation 1255 may be skipped.

In operation 1260, the electronic device 101 according to an embodiment may decide whether the scaling operation is necessary. For example, when a size of the obtained image is greater than a size of the image requested from the client, the electronic device 101 may decide that a down-scaling operation which reduces the image is necessary. For example, when the size of the obtained image is smaller than the size of the requested image, the electronic device 101 may decide that an up-scaling operation which enlarges the image is necessary. When a size of the obtained image is equal to a size of the image requested by the client, the electronic device 101 may decide that the scaling operation is not necessary. Based on the decision that the scaling operation is necessary, in operation 1265, the electronic device 101 according to an embodiment may perform the determined scaling operation. In an example, based on the decision that the scaling operation is not necessary, the operation 1265 may be skipped.

In operation 1270, the electronic device 101 according to an embodiment may decide whether an encoding operation is necessary. For example, when an image format of the obtained image is JPEG and an image format of the image stream requested by the client is NV21, the electronic device 101 may decide that the encoding operation is necessary. When the image format of the obtained image is identical to the image format of the image requested by the client, the electronic device 101 may decide that the encoding operation is not necessary. Based on the decision that the encoding operation is necessary, in operation 1275, the encoding operation may be performed in which the image format is encoded into an image format of the image stream requested by the client. In an example, based on the decision that the encoding operation is not necessary, the operation 1275 may be skipped.

In operation 1280, the electronic device 101 according to an embodiment may transfer an image obtained based on image data obtained as a result of performing at least one of the operations 1245, 1255, 1265, and 1275 or image data included in a replacement stream to a buffer for a surface requested by the client. In operation 1290, the client may obtain the image data from the buffer.

However, FIG. 12 is for explaining an example in which the electronic device 101 according to an embodiment provides at least one image stream to the client from the replacement stream, based on the crop operation or the scaling operation. A method of providing the at least one image stream to the client from the replacement stream may be implemented variously. For example, the order of performing the deciding operations or image processing operations of FIG. 12 may change from the order of FIG. 12, or at least some of the operations may be performed in parallel. Alternatively, for example, although it is illustrated that the deciding operations (the operations 1240, 1250, 1260, and 1270) of FIG. 12 are performed in the order of the operations 1240, 1250, 1260, and 1270, the order may change, or it may be implemented as a single operation in which at least one of the operations 1245, 1255, 1265, and 1275 is selectively performed or the image processing operation is skipped. Alternatively, for example, FIG. 12 may be implemented such that any one of the operations 1245, 1255, 1265, and 1275 is selectively performed.

FIG. 13 illustrates a user interface for configuring whether an electronic device allows a client to request for surface injection according to an embodiment of the disclosure.

Referring to FIG. 13, the electronic device 101 according to an embodiment may display a screen 1300 for managing the client through a display (e.g., the display module 160 of FIG. 1, the display module 160 of FIG. 2). For example, according to calling of an application which occupies or uses a camera (e.g., the camera module 180 of FIG. 1, the camera module 180 of FIG. 2) of the electronic device 101, the electronic device 101 may decide whether an additional image stream to be provided to a different client is further obtainable through the camera, based on a configuration of an image stream required for the camera by the called application. According to the decision that the additional image stream is further obtainable, the electronic device 101 may overlay an execution screen of an application or service which manages the client on the display module 160. For example, referring to FIG. 13, the electronic device 101 may display a screen including a toggle button 1310 for selecting whether to provide an image stream for displaying a preview screen to an external electronic device through a remote watch client which provides a screen mirroring function. For example, the electronic device 101 may control on/off of the screen mirroring function, based on a user input for selecting the toggle button 1310. The screen 1300 may be displayed as a full screen, or may be displayed in a form of a pop-up window displayed on at least part of the display. However, the form of displaying the screen 1300 is not limited thereto.

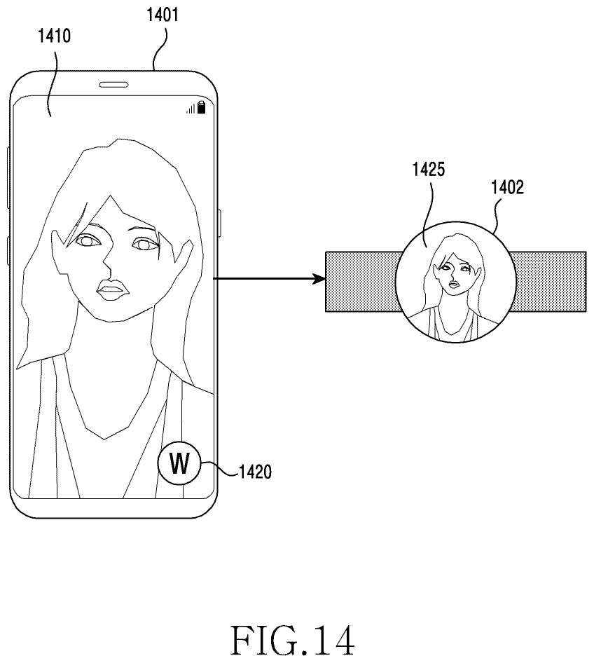

FIG. 14 illustrates an electronic device provides a service through a different client in a state where a camera is occupied by an application according to an embodiment of the disclosure.

Referring to FIG. 14, an electronic device 1401 may communicate with an external electronic device 1402 (e.g., the external electronic device 102 of FIG. 1). For example, the electronic device 1401 may be a smartphone, and the external electronic device 1402 may be a wearable device paired with the electronic device 1401. According to a camera-related application, the electronic device 1401 may display a preview screen 1410 displayed based on an image frame obtained from the camera. While displaying the preview screen 1410, the electronic device 1401 may additionally obtain at least one image stream 1425 requested by a client which mirrors the preview screen through the external electronic device 1402. For example, the electronic device 1401 may perform a process illustrated in at least one of the flowcharts 300, 400, 900, 1000, 1100, and 1200 illustrated in FIGS. 3, 4, 9, 10, 11, and 12. While the at least one image stream is provided to the external electronic device 1402, the electronic device 1401 may display through a display (e.g., the display module 160 of FIG. 1, the display module 160 of FIG. 2) a visual object 1420 (e.g., a floating icon) indicating that a mirroring service is provided through the client.

According to an embodiment of the disclosure, the electronic device 1401 may obtain information for creating an additional image stream from the client, and may examine whether an operation of creating the additional image stream is performed. For example, the electronic device 1401 may perform the aforementioned operation only when the client is authorized based on a public key or when a permission is granted through an explicit interaction (e.g., a user input for a pop-up window, a user input for displaying a message) between a user and the electronic device 1401.

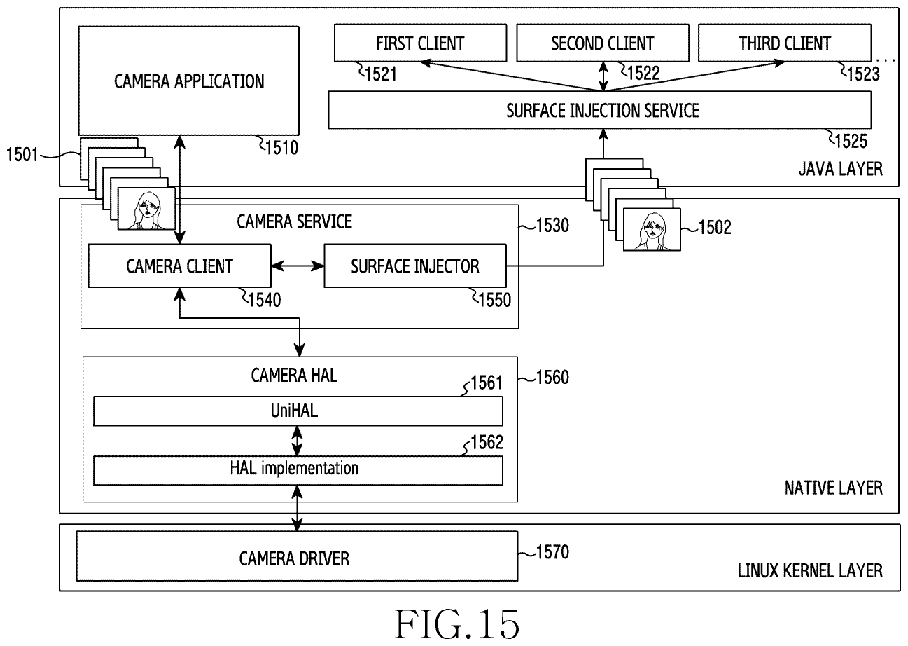

FIG. 15 is a block diagram illustrating a module included in an electronic device according to an embodiment of the disclosure. For example, a process illustrated in the aforementioned flowcharts 300, 400, 900, 1000, 1100, and 1200 may be performed by using the module illustrated in FIG. 15.

Referring to FIG. 15, at least one processor (e.g., the processor 120 of FIG. 1, the processor 120 of FIG. 2) may execute a camera application 1510 which occupies or uses a camera (e.g., the camera module 180 of FIG. 1, the camera module 180 of FIG. 2). For example, the electronic device 101 may perform an operation of the camera application 1510 through a Java layer, native layer, and Linux kernel layer supported by an operating system (e.g., Android™ OS) installed on the electronic device 101. For example, the Java layer may be a layer related to the camera application 1510, the native layer may be a layer related to middleware, and the Linux kernel layer may be a layer related to the operation system. However, FIG. 15 illustrates modules of the electronic device 101 according to some embodiments of the disclosure, and at least some of the modules illustrated in FIG. 15 may be replaced to perform similar functions.

According to various embodiments of the disclosure, the processor 120 may execute the camera application 1510, which occupies or uses the camera 180, a first client 1521, a second client 1522, a third client 1523, and/or a surface injection service 1525 on the Java layer.

According to various embodiments of the disclosure, the processor 120 may execute the camera application 1510, and may transmit information on the camera application 1510 to a camera service 1530. For example, the camera application 1510 may be an application provided by a third party which is not a provider of the electronic device 101.

According to an embodiment of the disclosure, the electronic device 101 may include the plurality of clients 1521, 1522, and 1523. For example, the first client 1521 may include a remote watch client which provides a function of mirroring a preview image to an external electronic device, the second client 1522 may include a motion photo client which provides a function of simultaneously capturing a still image and a moving image, and the third client 1523 may include a single take client which creates a plurality of still images or moving images, based on an image frame captured during a specified time interval. Although FIG. 15 illustrates three clients, technical ideas of the disclosure are not limited thereto.

According to various embodiments of the disclosure, the surface injection service 1525 may manage a surface transferred from the clients 1521, 1522, and 1523. The surface injection service 1525 may receive a surface of each of the clients 1521, 1522, and 1523 and information on the surface, and may transfer it to a surface injector 1550. The information on the surface may include, for example, an attribute (e.g., an image format or a resolution) of each of at least one second image stream. For example, the surface injection service 1525 may provide a requested image to each of the clients 1521, 1522, and 1523 from image data 1502 received from the surface injector.

According to various embodiments of the disclosure, the surface injection service 1525 may transfer surface information on the surface requested by each of the clients 1521, 1522, and 1523 to the surface injector 1550. In an embodiment of the disclosure, when at least one image stream is not configurable based on the surface transferred to the surface injector 1550, the surface injection service 1525 may receive from the surface injector 1550 a notification that the image stream is not configurable. For example, referring to FIG. 4, when it is decided in the operation 440 that the stream is not addable and when it is decided in the operation 450 that there is no same-type stream, the surface injection service 1525 may receive from the surface injector 1550 a notification that the image stream is not configurable. For example, based on the receiving of the notification that the image stream is not configurable, the surface injection service 1525 may configure a replacement surface (e.g., the image stream 821-2 of FIG. 8), and may transfer information on the replacement surface to the surface injector 1550.

According to various embodiments of the disclosure, the processor 120 may execute the camera service 1530 and a camera hardware abstraction layer (HAL) 1560 on the native layer.

According to various embodiments of the disclosure, the camera service 1530 may include a module which transmits and receives information between the camera 180 and the camera application 1510 for driving the camera 180. For example, the camera service 1530 may include a camera client 1540 and the surface injector 1550. The camera client 1540 may transmit a command for using the camera 180 and a response for a user input to the HAL 1560. The camera client 1540 may receive a command or information on the camera 180 from the surface injector 1550. The camera client 1540 may transfer the command or information on the camera 180 to the surface injector 1550. The surface injector 1550 may receive information on the camera 180 or camera application 1510 from the camera client 1540. For example, the surface injector 1550 may receive at least one of first information or second information from the camera client 1540. The first information may include information on image streams supportable by the camera HAL 1560. The second information may include information on at least one first image stream requested by the camera application 1510.

According to various embodiments of the disclosure, the surface injector 1550 may receive third information including at least one of surface information or a surface corresponding to a result requested by a client from the surface injection service 1525 of the Java layer. The surface injector 1550 may decide whether an image stream corresponding to the surface is configurable based on at least one of the first information, the second information, or the third information. The surface injector 1550 may transfer to the surface injection service 1525 whether the image stream is configurable. The surface injector 1550 may determine a configuration of the image stream, based on surface information and a surface finally determined from the surface injection service 1525. The surface injector 1550 may transfer the determined configuration of the image stream to the camera HAL 1560.

According to various embodiments of the disclosure, the camera HAL 1560 may include a module which transfers to the camera driver 1570 the surface information and surface received from the camera client 1540. For example, the camera HAL 1560 may transmit the camera driver 1570 a request to drive the camera 180 and to obtain an image, based on the configuration of the image stream determined by the surface injector 1550. The camera HAL 1560 may include a UniHAL 1561 and a HAL implementation 1562. The UniHAL 1561 may be a module for a common software solution except for a portion dependent on the processor 120 (e.g., a processor chipset). The HAL implementation 1562 may be a module including a software solution implemented in the camera HAL 1560 to control the camera 180.

According to various embodiments of the disclosure, the processor 120 may execute the camera driver 1570 on the Linux kernel layer. The camera driver 1570 may transmit and receive a command and/or information on the camera HAL 1560 and camera 180. For example, the camera driver 1570 may control the camera 180, based on the command received from the camera HAL 1560.

According to various embodiments of the disclosure, while the first image data 1501 is provided to the camera application 1510 by the camera client 1540, the second image data 1502 may be provided to each of the client 1521, 1522, and 1523 in a form requested by each of the clients 1521, 1522, and 1523 through the surface injection service 1525. The clients 1521, 1522, and 1523 may provide respective services, based on the provided image data.

In an embodiment of the disclosure, an electronic device (e.g., the electronic device 101 of FIG. 1, the electronic device 101 of FIG. 2, the electronic device 1401 of FIG. 14) may include a camera (e.g., the camera module 180 of FIG. 1, the camera module 180 of FIG. 2), memory (e.g., the memory 130 of FIG. 1, the memory 130 of FIG. 2) which stores instructions, and at least one processor (e.g., the processor 120 of FIG. 2, the processor 120 of FIG. 2). The instructions, when executed by the at least one processor, may cause the electronic device to execute an application (e.g., the camera application 1510 of FIG. 15) related to an operation of the camera. The instructions, when executed by the at least one processor, may cause the electronic device to execute a client (e.g., the first client 1521, second client 1522, and third client 1523 of FIG. 15,) distinct from the executed application. The instructions, when executed by the at least one processor, may cause the electronic device to determine a configuration of an image stream, based on information on image streams supportable in relation to the camera. The instructions, when executed by the at least one processor, may cause the electronic device to initiate the operation of the camera, based on the determined configuration of the image stream. The instructions, when executed by the at least one processor, may cause the electronic device to obtain image data corresponding to the determined configuration of the image stream through the camera, based on a request of the executed application. The instructions, when executed by the at least one processor, may cause the electronic device to store the image data in a buffer allocated to the memory. The instructions, when executed by the at least one processor, may cause the electronic device to allow the client to obtain at least one image stream, based on the image data, through the buffer.

In an embodiment of the disclosure, the instructions, when executed by the at least one processor, may cause the electronic device determine the configuration of the image stream, based on at least one of first information on image streams supportable simultaneously in a camera hardware abstraction layer, second information on at least one first image stream requested by the executed application, or third information on at least one second image stream requested by the client.

In an embodiment of the disclosure, the second information may include at least one of information on a resolution or information on a format for each of the at least one first image stream. The third information may include at least one of information on a resolution or information on a format for each of the at least one second image stream.

In an embodiment of the disclosure, the instructions, when executed by the at least one processor, may cause the electronic device to determine whether the at least one second image stream is addable to the supportable image streams in a state where the at least one first image stream is included, based on at least one of the first information, the second information, or the third information. The instructions, when executed by the at least one processor, may cause the electronic device to determine a configuration in which the at least one second image stream is added to the at least one first image stream as the configuration of the image stream, based on that the determination that the at least one second image stream is addable to the supportable image streams in the state where the at least one first image stream is included.

In an embodiment of the disclosure, the instructions, when executed by the at least one processor, may cause the electronic device to determine whether the at least one first image stream includes an image stream having the same attribute as the at least one second image stream, based on the determination that the at least one second image stream is not addable. The instructions, when executed by the at least one processor, may cause the electronic device to determine a configuration of the image stream in which, among the at least one first image stream, an image stream having the same attribute as the at least one second image stream is configured as a shared stream shared by the application and the client, based on the determination that the at least one first image stream includes an image stream having the same attribute as the at least one second image stream.

In an embodiment of the disclosure, the instructions, when executed by the at least one processor, may cause the electronic device to determine whether a replacement stream which replaces the at least one second image stream is addable to the supportable image stream, based on the determination that the stream provided to the client is not configurable using the shared stream. The instructions, when executed by the at least one processor, may cause the electronic device to determine a configuration in which the replacement stream is added to the at least one first image stream as a configuration of the image stream, based on the determination that the replacement stream is addable to the supportable image stream.

In an embodiment of the disclosure, the instructions, when executed by the at least one processor, may cause the electronic device to, based on the decision that the replacement stream is not addable to the supportable image stream, determine a configuration including the at least one image stream as the configuration of the image stream and transfer to the client a dialog which notifies that the image stream is unavailable.

In an embodiment of the disclosure, the instructions, when executed by the at least one processor, may cause the electronic device to compare an attribute of the replacement stream and the third information, and determine whether to perform at least one image processing operation on an image included in the replacement stream, based on a result of the comparison. The instructions, when executed by the at least one processor, may cause the electronic device to perform at least part of the at least one image processing operation, based on a result of the determination on whether to perform the at least one image processing operation. The instructions, when executed by the at least one processor, may cause the electronic device to store image data obtained as a result of performing the at least part of the at least one image processing operation to the buffer.

In an embodiment of the disclosure, the at least one image processing operation may include at least one of a crop operation, a color space conversion operation, a scaling operation, or an encoding operation. The crop operation may include an operation of cropping at least part of the image included in the replacement stream, based on the third information. The color space conversion operation may include an operation of converting a color space of the image included in the replacement stream, based on the third information. The scaling operation may include an operation of enlarging or reducing the image included in the replacement stream, based on the third information. The encoding operation may include an operation of converting a format of the image included in the replacement stream, based on the third information.

In an embodiment of the disclosure, the electronic device may further include a display (e.g., the display module 160 of FIG. 1, the display module 160 of FIG. 2) and a communication circuit (e.g., the communication module 190 of FIG. 1, the communication circuit 190 of FIG. 2). The instructions, when executed by the at least one processor, may cause the electronic device to display a screen including a preview image provided by the application and a visual object corresponding to the client through the display, based on the image data stored in the buffer. The instructions, when executed by the at least one processor, may cause the electronic device to transmit an image stream requested by the client to an external electronic device through the communication circuit, so that an image corresponding to the preview image is displayed through the external electronic device while the preview image is displayed through the display, based on the image data stored in the buffer.

A method of operating an electronic device (e.g., the electronic device 101 of FIG. 1, the electronic device 101 of FIG. 2) including a camera (e.g., the camera module 180 of FIG. 1, the camera module 180 of FIG. 2) may include executing an application related to an operation of the camera. The method may further include executing a client distinct from the executed application. The method may further include determining a configuration of an image stream, based on information on image streams supportable in relation to the camera. The method may further include initiating the operation of the camera, based on the determined configuration of the image stream. The method may further include obtaining image data corresponding to the determined configuration of the image stream through the camera, based on a request of the executed application. The method may further include providing the executed application with at least one first image stream requested by the application, based on the image data, and providing the client with at least one second image stream requested by the client.

In an embodiment of the disclosure, the determining of the configuration of the image stream may include determine the configuration of the image stream, based on at least one of first information on image streams supportable simultaneously in a camera hardware abstraction layer, second information on at least one first image stream, or third information on at least one second image stream.

In an embodiment of the disclosure, the second information may include at least one of information on a resolution or information on a format for each of the at least one first image stream. The third information may include at least one of information on a resolution or information on a format for each of the at least one second image stream.

In an embodiment of the disclosure, the determining of the configuration of the image stream may include determining whether the at least one second image stream is addable to the supportable image streams in a state where the at least one first image stream is included, based on at least one of the first information, the second information, or the third information. The determining of the configuration of the image stream may further include determining a configuration in which the at least one image stream is added to the at least one first image stream as the configuration of the image stream, based on the determination that the at least one second image stream is addable to the supportable image streams in the state where the at least one first image stream is included.

In an embodiment of the disclosure, the determining of the configuration of the image stream may include determining whether the at least one first image stream includes an image stream having the same attribute as the at least one second image stream, based on the determination that the at least one second image stream is not addable. The determining of the configuration of the image stream may further include determining a configuration of the image stream in which, among the at least one first image stream, an image stream having the same attribute as the at least one second image stream is configured as a shared stream shared by the application and the client, based on the determination that the at least one first image stream includes an image stream having the same attribute as the at least one second image stream.

In an embodiment of the disclosure, the determining of the configuration of the image stream may include determining whether a replacement stream which replaces the at least one second image stream is addable to the supportable image stream, based on the determination that the stream provided to the client is not configurable using the shared stream. The determining of the configuration of the image stream may further include determining a configuration in which the replacement stream is added to the at least one first image stream as a configuration of the image stream, based on the determination that the replacement stream is addable to the supportable image stream.

In an embodiment of the disclosure, the method may further include, based on the decision that the replacement stream is not addable to the supportable image stream, determining a configuration including the at least one image stream as the configuration of the image stream and transferring to the client a dialog which notifies that the image stream is unavailable.

In an embodiment of the disclosure, the providing of the image stream may include comparing an attribute of the replacement stream and the third information. The providing of the image stream may further include determining whether to perform at least one image processing operation on an image included in the replacement stream, based on a result of the comparison. The providing of the image stream may further include performing at least part of the at least one image processing operation, based on a result of the determination on whether to perform the at least one image processing operation. The providing of the image stream may further include providing the client with a result of performing at least part of the at least one image processing operation as the at least one second image stream.

In an embodiment of the disclosure, the at least one image processing operation may include at least one of a crop operation, a color space conversion operation, a scaling operation, or an encoding operation. The crop operation may include an operation of cropping at least part of the image included in the replacement stream, based on the third information. The color space conversion operation may include an operation of converting a color space of the image included in the replacement stream, based on the third information. The scaling operation may include an operation of enlarging or reducing the image included in the replacement stream, based on the third information. The encoding operation may include an operation of converting a format of the image included in the replacement stream, based on the third information.

In an embodiment of the disclosure, the method may further include displaying a screen including a preview image provided by the application and a visual object corresponding to the client through a display, based on the first image data. The method may further include transmitting the second image stream to an external electronic device, so that an image corresponding to the preview image is displayed through the external electronic device while the preview image is displayed through the display, based on the second image stream.

An electronic device and an operation method thereof according to various embodiments may reliably provide various functions related to a camera of the electronic device without additional modifications or structural changes in various applications related to an operation of the camera. According to various embodiments of the disclosure, the electronic device and the operation method thereof may be provided to allow a camera-related service provided by the electronic device to be used in a camera-related application externally provided.

The electronic device and the operation method thereof according to various embodiments do not require the additional modifications or changes in the various applications related to the operation of the camera, thereby preventing the occurrence of costs caused by the additional modifications or structural changes in the application.

Advantages acquired in the disclosure are not limited to the aforementioned advantages, and other advantages not mentioned herein may be clearly understood by those skilled in the art to which the disclosure pertains from the following descriptions.

Methods based on the embodiments disclosed in the claims and/or specification of the disclosure may be implemented in hardware, software, or a combination of both.

When implemented in software, a computer readable recording medium for storing one or more programs (i.e., software modules) may be provided. The one or more programs stored in the computer readable recording medium are configured for execution performed by one or more processors in the electronic device. The one or more programs include instructions for allowing the electronic device to execute the methods based on the embodiments disclosed in the claims and/or specification of the disclosure.

The program (i.e., the software module or software) may be stored in random access memory, non-volatile memory including flash memory, read only memory (ROM), electrically erasable programmable read only memory (EEPROM), magnetic disc storage device, compact disc-ROM (CD-ROM), digital versatile discs (DVDs) or other forms of optical storage devices, and a magnetic cassette. Alternatively, the program may be stored in memory configured in combination of all or some of these storage media. In addition, the configured memory may be plural in number.

Further, the program may be stored in an attachable storage device capable of accessing the electronic device through a communication network, such as the Internet, an Intranet, a local area network (LAN), a wide LAN (WLAN), or a storage area network (SAN) or a communication network configured by combining the networks. The storage device may have access to a device for performing an embodiment of the disclosure via an external port. In addition, an additional storage device on a communication network may have access to the device for performing the embodiment of the disclosure.

In the aforementioned specific embodiments of the disclosure, a component included in the disclosure is expressed in a singular or plural form according to the specific embodiment proposed herein. However, the singular or plural expression is selected properly for a situation proposed for the convenience of explanation, and thus the various embodiments of the disclosure are not limited to a single or a plurality of components. Therefore, a component expressed in a plural form may also be expressed in a singular form, or vice versa.

In addition, in the disclosure, the term “unit”, “module”, or the like may be a hardware component, such as a processor or a circuit, and/or a software component executed by the hardware component, such as the processor.

The “unit” and the “module” may be implemented by a program stored in an addressable storage medium and executable by the processor. For example, the “unit” and “module” may be implemented by software components, object-oriented software components, class components, and task components, processes, functions, attributes, procedures, subroutines, segments of program code, drivers, firmware, microcode, circuitry, data, databases, data structures, tables, arrays, and variables.

Specific implementations described in the disclosure are only one embodiment of the disclosure, and do not limit the scope of the disclosure in any way. For brevity of the specification, descriptions on the electronic components of the related art, control systems, software, and other functional aspects of the systems may be omitted.

In addition, in the disclosure, “including at least one of a, b, or c” may mean “including only a”, “including only b”, “including only c”, “including a and b”, “including b and c”, “including a and c”, or “including a, b, and c”.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a camera;
memory, comprising one or more storage media, storing instructions; and
at least one processor communicatively coupled to the camera and the memory,
wherein the instructions, when executed by the at least one processor individually or collectively, cause the electronic device to:
execute an application related to an operation of the camera,
execute a client distinct from the executed application,
determine a configuration of an image stream, based on information on image streams supportable in relation to the camera,
initiate the operation of the camera, based on the determined configuration of the image stream,
obtain image data corresponding to the determined configuration of the image stream through the camera, based on a request of the executed application,
store the image data in a buffer allocated to the memory, and
allow the client to obtain at least one image stream, based on the image data, through the buffer.

2. The electronic device of claim 1, wherein the instructions, when executed by the at least one processor individually or collectively, further cause the electronic device to determine the configuration of the image stream, based on at least one of first information on image streams supportable simultaneously in a camera hardware abstraction layer, second information on at least one first image stream requested by the executed application, or third information on at least one second image stream requested by the client.

3. The electronic device of claim 2,
wherein the second information includes at least one of information on a resolution or information on a format for each of the at least one first image stream, and
wherein the third information includes at least one of information on a resolution or information on a format for each of the at least one second image stream.

4. The electronic device of claim 2, wherein the instructions, when executed by the at least one processor individually or collectively, further cause the electronic device to:
determine whether the at least one second image stream is addable to the supportable image streams in a state where the at least one first image stream is included, based on at least one of the first information, the second information, or the third information, and
determine a configuration in which the at least one second image stream is added to the at least one first image stream as the configuration of the image stream, based on the determination on the at least one second image stream is addable to the supportable image streams in the state where the at least one first image stream is included.

5. The electronic device of claim 4, wherein the instructions, when executed by the at least one processor individually or collectively, further cause the electronic device to:
determine whether the at least one first image stream includes an image stream having the same attribute as the at least one second image stream, based on the
determination that the at least one second image stream is not addable, and determine a configuration of the image stream in which, among the at least one first image stream, an image stream having the same attribute as the at least one second image stream is configured as a shared stream shared by the application and the client, based on the determination that the at least one first image stream includes an image stream having the same attribute as the at least one second image stream.

6. The electronic device of claim 5, wherein the instructions, when executed by the at least one processor individually or collectively, further cause the electronic device to:
determine whether a replacement stream which replaces the at least one second image stream is addable to the supportable image stream, based on the determination that the stream provided to the client is not configurable using the shared stream, and
determine a configuration in which the replacement stream is added to the at least one first image stream as a configuration of the image stream, based on the determination that the replacement stream is addable to the supportable image stream.

7. The electronic device of claim 6, wherein the instructions, when executed by the at least one processor individually or collectively, further cause the electronic device to, based on the determination that the replacement stream is not addable to the supportable image stream, determine a configuration including the at least one first image stream as the configuration of the image stream and transfer to the client a dialog which notifies that the image stream is unavailable.

8. The electronic device of claim 6, wherein the instructions, when executed by the at least one processor individually or collectively, further cause the electronic device to:
compare an attribute of the replacement stream and the third information,
determine whether to perform at least one image processing operation on an image included in the replacement stream, based on a result of a comparison,
perform at least part of the at least one image processing operation, based on a result of the determination on whether to perform the at least one image processing operation, and
store image data obtained as a result of performing the at least part of the at least one image processing operation to the buffer.

9. The electronic device of claim 8,
wherein the at least one image processing operation includes at least one of a crop operation, a color space conversion operation, a scaling operation, or an encoding operation,
wherein the crop operation includes an operation of cropping at least part of the image included in the replacement stream, based on the third information,
wherein the color space conversion operation includes an operation of converting a color space of the image included in the replacement stream, based on the third information,
wherein the scaling operation includes an operation of enlarging or reducing the image included in the replacement stream, based on the third information, and
wherein the encoding operation includes an operation of converting a format of the image included in the replacement stream, based on the third information.

10. The electronic device of claim 1, further comprising:
a display; and
a communication circuit,
wherein the instructions, when executed by the at least one processor individually or collectively, further cause the electronic device to:
display a screen including a preview image provided by the application and a visual object corresponding to the client through the display, based on the image data stored in the buffer, and
transmit an image stream requested by the client to an external electronic device through the communication circuit, so that an image corresponding to the preview image is displayed through the external electronic device while the preview image is displayed through the display, based on the image data stored in the buffer.

11. A method of operating an electronic device including a camera, the method comprising:
executing an application related to an operation of the camera;
executing a client distinct from the executed application;
determining a configuration of an image stream, based on information on image streams supportable in relation to the camera;
initiating the operation of the camera, based on the determined configuration of the image stream;
obtaining image data corresponding to the determined configuration of the image stream through the camera, based on a request of the executed application; and
providing the executed application with at least one first image stream requested by the application, based on the image data, and providing the client with at least one second image stream requested by the client.

12. The method of claim 11, wherein the determining of the configuration of the image stream includes determining the configuration of the image stream, based on at least one of first information on image streams supportable simultaneously in a camera hardware abstraction layer, second information on at least one first image stream, or third information on at least one second image stream.

13. The method of claim 12,
wherein the second information includes at least one of information on a resolution or information on a format for each of the at least one first image stream, and
wherein the third information includes at least one of information on a resolution or information on a format for each of the at least one second image stream.

14. The method of claim 12, wherein the determining of the configuration of the image stream includes:
determining whether the at least one second image stream is addable to the supportable image streams in a state where the at least one first image stream is included, based on at least one of the first information, the second information, or the third information; and
determining a configuration in which the at least one second image stream is added to the at least one first image stream as the configuration of the image stream, based on the determination that the at least one second image stream is addable to the supportable image streams in the state where the at least one first image stream is included.

15. The method of claim 11, further comprising:
displaying a screen including a preview image provided by the application and a visual object corresponding to the client through a display, based on first image data; and
transmitting the second image stream to an external electronic device, so that an image corresponding to the preview image is displayed through the external electronic device while the preview image is displayed through the display, based on the second image stream.

16. The method of claim 14, further comprising:
determining whether the at least one first image stream includes an image stream having the same attribute as the at least one second image stream, based on the determination that the at least one second image stream is not addable; and
determining a configuration of the image stream in which, among the at least one first image stream, an image stream having the same attribute as the at least one second image stream is configured as a shared stream shared by the application and the client, based on the determination that the at least one first image stream includes an image stream having the same attribute as the at least one second image stream.

17. The method of claim 16, further comprising:
determining whether a replacement stream which replaces the at least one second image stream is addable to the supportable image stream, based on the determination that the stream provided to the client is not configurable using the shared stream; and
determining a configuration in which the replacement stream is added to the at least one first image stream as a configuration of the image stream, based on the determination that the replacement stream is addable to the supportable image stream.

18. The method of claim 17, further comprising:
based on the determination that the replacement stream is not addable to the supportable image stream, determining a configuration including the at least one first image stream as the configuration of the image stream and transfer to the client a dialog which notifies that the image stream is unavailable.

19. One or more non-transitory computer-readable storage media storing one or more computer programs including computer-executable instructions that, when executed by at least one processor of an electronic device individually or collectively, cause the electronic device to perform operations, the operations comprising:
executing an application related to an operation of a camera;
executing a client distinct from the executed application;
determining a configuration of an image stream, based on information on image streams supportable in relation to the camera;
initiating the operation of the camera, based on the determined configuration of the image stream;
obtaining image data corresponding to the determined configuration of the image stream through the camera, based on a request of the executed application; and
providing the executed application with at least one first image stream requested by the application, based on the image data, and providing the client with at least one second image stream requested by the client.

20. The one or more non-transitory computer-readable storage media of claim 19, wherein the determining of the configuration of the image stream includes determining the configuration of the image stream, based on at least one of first information on image streams supportable simultaneously in a camera hardware abstraction layer, second information on at least one first image stream, or third information on at least one second image stream.
